(19) United States
(12) Patent Application Publication
(10) Pub. No.: US 2006/0286211 A1
(43) Pub. Date: Dec. 21, 2006

(54) Temperature sensing material

(76) Inventor: Scott R. Lang, Geneva, IL (US)

Correspondence Address: HONEYWELL INTERNATIONAL INC., 101 COLUMBIA ROAD, P O BOX 2245, MORRISTOWN, NJ, 07962-2245, US

(21) Appl. No.: 11/157,022

(22) Filed: Jun. 20, 2005

(51) Int. Cl. G01N 31/22

(52) U.S. Cl. 426/88

(57) ABSTRACT

Food safety can be enhanced by applying a temperature indicating element to packaging for a food product. The element can be applied before or after the food product has been inserted into the packaging. The color of the element indicates if the temperature of the packaged food product has rise to an unsafe level, and/or, has stayed at or above that level for a predetermined time interval.

### FIELD OF THE INVENTION

The invention pertains to food safety devices and methods. More particularly the invention pertains to temperature responsive indicators affixable to food products.

### BACKGROUND OF THE INVENTION

Food products such as frozen foods, dairy products, various types of juices and the like generally must be stored at a temperature below a predetermined value to maintain product freshness and safety. In this regard, it is undesirable to have food products of the type noted above exposed for any significant period of time to temperatures above their safe storage temperature.

While food product packages including the containers for fluids such as milk or juice, frozen food containers or the like usually contain or carry a date after which the product is preferably not to be sold, such packaging does not usually carry any indicators as to temperatures that the food product might have been subjected to in transit or while at the respective retail outlet.

From the point of view of consumers, as well as the food product merchandisers, there are benefits to being able to recognize, ahead of time, where one or more food products might have deteriorated due to temperature. For example, if a case of frozen food product was left out of the freezer for an extended period of time, more likely than not the vendor would want to remove those food products from inventory to avoid inadvertent sales or other distribution to retail customers.

There continues to be a need for food product packaging which would not only carry a “sell by” date but also would carry an indicator of any excessive temperature to which the respective food product had been subjected to subsequent to manufacture and before final sale. Preferably such indicators would be irreversible such that if the food product warmed to a temperature above the storage temperature and then was cooled again, the indicator would not revert to its initial color. It would also be preferable if such indicators could be incorporated into food product packaging with minimal additional cost.

### BRIEF DESCRIPTION OF THE DRAWINGS

FIG. 1A is a side elevational view of an exemplary product in accordance with the invention;

FIG. 1B is a top plan view of a different type of product in accordance with the invention;

FIG. 2A is a top plan view of a roll of temperature responsive material usable on the product packaging of FIG. 1A or FIG. 1B; and

FIG. 2B is a side elevational view of the roll of material of FIG. 2A.

### DETAILED DESCRIPTION OF THE EMBODIMENTS

While this invention is susceptible of embodiment in many different forms, there are shown in the drawing and will be described herein in detail specific embodiments thereof with the understanding that the present disclosure is to be considered as an exemplification of the principles of the invention and is not intended to limit the invention to the specific embodiments illustrated.

A material which embodies the present invention makes a one-time change between two readily distinguishable colors when the material experiences a temperature drop below a set point and subsequently the temperature of the material rises back above set point. A coating of the material can be placed directly on product packaging. Alternately, material in accordance with the invention can be deposited on a layer which could also carry a layer of adhesive or directly on a layer of adhesive material.

In one aspect of the invention, a multilayer product can include a layer of temperature responsive material, deposited onto an inert elongated body layer which also carries a layer of adhesive. This embodiment of the invention can exhibit an elongated tape-like shape which can be wound onto a core forming a dispensing roll.

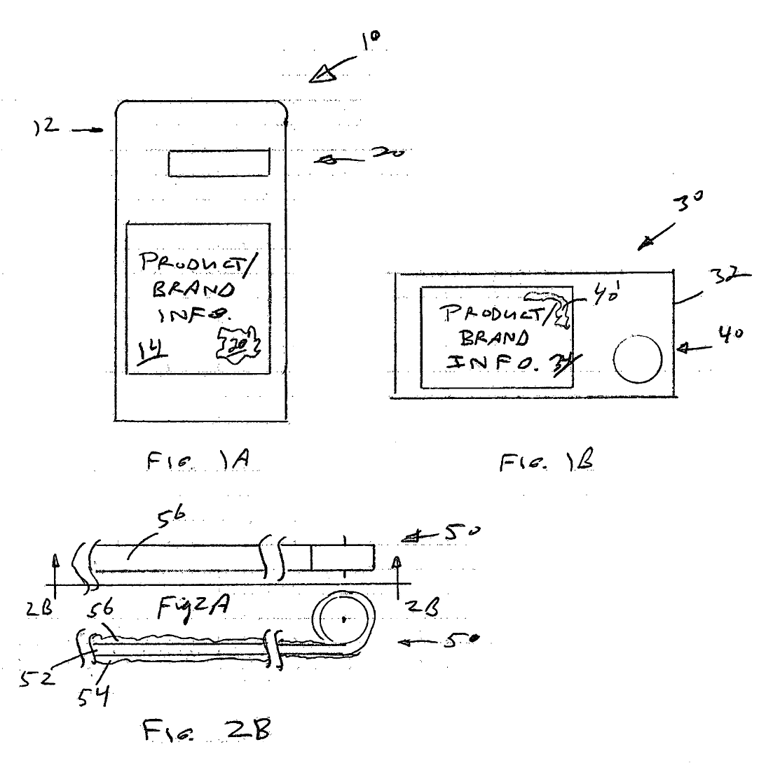

FIG. 1A, a side elevational view of a container of a liquid food product 10, for example milk, juice or the like, carries a dispensing or pouring region of a conventional type 12. The container 12 also carries product and brand information of a conventional type 14.

In accordance with the invention, the container 12 also carries a temperature sensitive material 20. The material 20 can be deposited directly onto the container 10. Alternately, the material 20 can be applied to an inert underlying base layer which carries an adhesive layer. The base layer and material 20 can be attached to the container 10.

While the material 20 is illustrated with a rectangular shape, neither shape nor position are limitations of the invention. For example, as an alternative, an arbitrarily shaped deposit 20′, shown integral with the product and brand information, could be used.

The material 20 exhibits first and second readily discernible colors. Preferably, material 20 exhibits a first color at room, or processing temperature and retains that color, from normal room or processing temperature, to a lower temperature of a value compatible with the food product carried by the container 10. For example, the material 20 could exhibit a first color, assuming the food product was milk or juice, throughout the entire time that the container of milk or juice 10 was filled, sealed and was kept at or below a safe storage temperature. Similarly, the material 20 could be applied to other types of non-frozen food products which need to be kept at a relatively low temperature.

The material 20 irreversibly changes to a second, different color in response to rising above a safe storage temperature for the respective food product, milk or juice in this example. The second color provides an indication to consumers that the product 10 has risen to a temperature above the safe storage temperature. The irreversible nature of the color change continues to inform the consumer even when the temperature of the product 10 has been subsequently reduced to the safe storage region.

FIG. 1B is a top plan view of another food product package 30, which, for example could contain a frozen food product such as frozen juice, a frozen dinner, a frozen dessert or the like. The product 30 includes an appropriate form of container 32 which contains the food product as well as product and brand information 34.

The container 32 also carries a circular temperature responsive region 40 which exhibits a first color when initially produced and throughout the entire time that the product in package 30 remain at a safe storage temperature, preferably below freezing. If the packaging 30 increases in temperature above a safe storage temperature, for example freezing, the material 40 will permanently change color and exhibit its second color indicative of the product 30 having been exposed to temperatures above the safe storage temperature.

It will be understood that, as an alternate, the temperature responsive material can be provided in any arbitrary shape or location on container 32. For example, material 40 can be integrated with product/brand information 34 in a shape compatible therewith.

Relative to both the products 10 and 30, the consumer can readily ascertain whether the product has been continuously maintained at or below its safe storage temperature by viewing the respective material 20, 20′ or 40, 40′. Since the material 20, 20′ or 40, 40′ exhibits a one-time color change in response to rising above its predetermined safe storage temperature, the consumer can immediately ascertain which packages of product can be expected to be safe for consumption.

FIG. 2A is a top plan view of a roll 50 of a representative form of a temperature sensitive material, such as the material 20. FIG. 2B is a side elevational view of the roll 50 of FIG. 2A.

The roll 50 is formed with an inert elongated base layer 52. The layer 52 can be formed of any material, such as paper or resin, acceptable for use in connection with food products. It will be understood that the exact characteristics of the layer 52 are not a limitation of the present invention.

The layer 52 carries an adhesive layer 54 for attachment to a food product container such as containers 12 or 32. The layer 54 also carries temperature sensitive material 56 which, as described above, exhibits a first color when manufactured and when exposed to an acceptable food storage temperature, dependent upon the type of food product associated with the material 56. That material exhibits a second and permanent color in response to the temperature thereof rising above the safe storage temperature of the respective food product.

Those of skill in the art will also understand that the adhesive 54 and material 56 could be mixed and deposited directly on the container 12 in an alternate embodiment, in a circular shape, corresponding to the shape 40 on the container 32, or in any other shape. If desired, the material 56 could be applied, whether carried on a layer 52 or directly as described above, in a decorative shape to blend into and be compatible with the product and brand information 14 or 34.

The shapes 20, 40 could be formed spaced apart on a release layer. It will be understood that all such configurations come within the spirit and scope of the present invention.

In summary, the temperature sensitive material 56, which could be placed on product packaging in exemplary form 20, 20′ in FIG. 1A or could be placed on product packaging in exemplary form 40, 40′ presents to the consumer a readily ascertainable indicator that the respective food product has been consistently stored at or below its safe storage temperature. Once the temperature sensitive material experiences a temperature in excess of the safe storage temperature of the respective food product it exhibits a permanent color change thereby informing the consumer that the respective package should not be purchased.

In an alternate embodiment, the temperature sensitive material can be configured to spell out a warning, such as “spoiled”, or “do not use”. In yet another embodiment, the temperature sensitive material can surround letters of a warning word or phrase. In this embodiment, if the temperature sensitive material changes color, the warning word or phrase will appear in the initial color surrounded by the second, temperature responsive color.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

What is claimed:

1. A method of food product monitoring comprising:
determining an acceptable upper storage temperature for a food product;
forming a temperature responsive material having first and second color indicia, the first color is presented when the element is at a temperature below the storage temperature, and the second color is presented subsequent to the material attaining a temperature which exceeds the upper storage temperature for the food product;
packaging the food product;
applying the material to the packaging;
maintaining the food product at a local ambient temperature; presenting the food product to an end user; and
determining the color the material is displaying.

2. A method as in claim 1 which includes accepting the food product where the material is presenting the first color, indicating that the food product did not attain the food storage temperature.

3. A method as in claim 1 and responsive to determining, accepting or rejecting the food product in accordance with a color being displayed by the material.

4. A method as in claim 1 including forming the material as one of a strip, or non-rectangular shape.

5. A method as in claim 4 which includes forming the material with a base layer and a displaced adhesive layer.

6. A method as in claim 5 where affixing includes adhering the material to the packaging by means of the adhesive layer.

7. A method as in claim 1 which includes forming the material as a multi-layered element having an adhesive layer.

8. A method as in claim 7 where affixing includes adhering the element to the packaging by means of the adhesive layer.

9. A method as in claim 1 where affixing includes one of applying adhesive, applying RF signals or applying pressure.

10. A method as in claim 1 where the material is integrated into a label for the food product.

11. A method as in claim 10 where the material is deposited on one of a container or a label for a container.

12. An article comprising:
a consumable food product which has a non-spoiling storage temperature value below a predetermined value;
a package which contains the food product, the package being sealed prior to being opened for consumption, at least in part, of the contained food product;
a temperature marker carried by the sealed package, the marker providing a visual indication as to whether a temperature parameter of the food product has exceeded the predetermined value.

13. An article as in claim 12 where the package comprises one of a container for fluids, or, a container for solids.

14. An article as in claim 12 where the marker is responsive to the presence of at least a predetermined temperature for a predetermined time interval.

15. An article as in claim 12 where the marker comprises one of a deposit on the package, or, a separate member, of a selected shape, carried by the package.

16. An article as in claim 15 where the member has one of a polygonal or a curved periphery, at least in part.

17. A member comprising:
a base layer; and
a temperature responsive material carried by the base layer.

18. A member as in claim 17 where the base layer carries adhesive displaced from the temperature responsive material.
